(19) United States
(12) Patent Application Publication
(10) Pub. No.: US 2005/0166317 A1
(43) Pub. Date: Aug. 4, 2005

(54) Method of manufacture and products using fabric in injection molding

(76) Inventor: Ray G. Kelly, St. Louis, MO (US)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 11/030,426

(22) Filed: Jan. 5, 2005

Related U.S. Application Data
(60) Provisional application No. 60/541,133, filed on Feb. 2, 2004.

(51) Int. Cl. A47C 17/00; A61G 1/00

(52) U.S. Cl. 5/110; 5/625

(57) ABSTRACT

Certain embodiments of the present invention provide a method for manufacturing injection plastic molded articles incorporating a fabric material, and articles made thereby. In one preferred method, a fabric type material is placed into an open plastic injection mold. The mold is then closed, creating a cavity around a portion of the fabric type material. Liquid plastic is introduced into the mold to permeate the fabric portion. The plastic is then cured with the fabric portion embedded in the plastic. One example of a product incorporating fabric incorporated into a plastic injection molded piece is a cot assembly.

The present application claims priority to provisional application Ser. No. 60/541,133, filed Feb. 2, 2004, which is incorporated herein by reference.

### FIELD OF THE INVENTION

The present invention relates generally to plastic injection molding, and more particularly to a method of injection molding incorporating a fabric into a plastic molded product. One example of such a product is a cot assembly.

### BACKGROUND OF THE INVENTION

The general method of plastic injection molding is well known, including using a heated and sealed mold into which a liquid plastic material is introduced and then cured into a desired shape. Molded products have many material strengths. However, one drawback to traditional injection molding is the weakness inherent in an assembled article when the molded product transitions to a non-molded material, such as a fabric. Generally, a separate fastener mechanism has been required to attach the molded portion to a fabric, creating a potential point failure source between the fabric material and the plastic molded portion.

One example is demonstrated in a cot assembly. In one typical cot, it is desired to attach the soft, middle portion, such as a woven material to a plastic molded end cap. Traditionally, this has required separate fasteners, such as posts, clips or brackets. However, when the fabric is placed under stress, for example by a person lying on the cot, the fabric tends to “pull away” from the fastener, and potentially tears or unravels, leading to a connection failure.

There has been a long-felt need in the industry for an improved fabric to plastic interface;

however, previous efforts to solve this problem have been unsuccessful and have created skepticism in the industry. A need remains for an improved method to form integrated fabric and plastic molded products.

The present invention satisfies these needs, among others.

### SUMMARY OF THE INVENTION

Certain embodiments of the present invention provide a method for manufacturing injection plastic molded articles incorporating a fabric material, and articles made thereby. In a preferred method, a woven or fabric type material is partially placed into an open plastic injection mold. The mold is then closed, defining a cavity around a portion of the fabric type material. Liquid plastic is introduced into the mold, causing the liquid material to permeate the fabric portion. The plastic is then cured with the fabric portion embedded in the plastic.

One example of a product having fabric incorporated into a plastic molded piece is a cot assembly. The cot includes a perimeter structure and a fabric middle portion, where one or two of the fabric ends are cured within plastic portions to form integrated edge pieces, such that each edge piece is easily connectable to the cot structure. The finished edge pieces spread the interface tension between the fabric and plastic portion substantially along the width of the edge piece.

Objects and advantages of the present invention will be apparent from the following description of the preferred embodiments.

### BRIEF DESCRIPTION OF THE DRAWINGS

FIG. 1 is a perspective view of a lower mold portion according to a preferred embodiment of the present invention.

FIG. 2 is a perspective view of an upper mold portion according to a preferred embodiment of the present invention.

FIG. 3 is a perspective view of a lower mold portion of FIG. 1 with a fabric material in place.

FIGS. 4A and 4B illustrate top and bottom views of a molded end portion according to a preferred embodiment of the present invention.

FIGS. 5A-5D illustrate molded end piece assembly methods for a cot.

FIG. 6 is a perspective view of a cot assembly made according to one preferred embodiment of the present invention.

FIGS. 7A and 7B illustrate top and bottom views of a molded end portion according to an alternate preferred embodiment of the present invention.

### DESCRIPTION OF PREFERRED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

Certain embodiments of the present invention provide an improved method for manufacturing injection plastic molded articles incorporating a woven or fabric material, and articles made thereby. In a preferred method, a portion of a fabric type material is partially placed into an open plastic injection mold. The mold is then closed, defining a cavity around a portion of the fabric type material. Liquid plastic is introduced into the mold, causing the liquid material to permeate the fabric portion. The plastic is then cured with the fabric portion embedded in the plastic. The finished piece is removed from the mold.

One example of a product incorporating a fabric material incorporated into a plastic molded piece is a cot assembly. The cot includes a perimeter structure and a fabric middle portion, where one, two or more of the fabric edges or ends are cured within plastic portions to form integrated end pieces, such that each end piece is easily connectable to the cot structure or frame. The finished piece preferably spreads the interface tension between the fabric and plastic portion, for example substantially along the width of an edge.

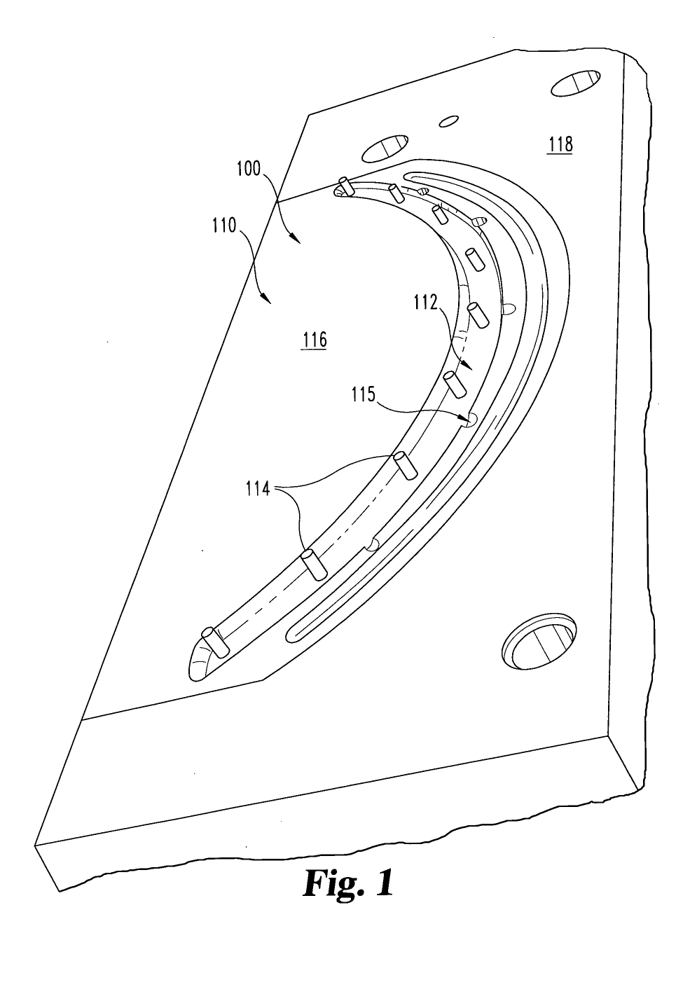

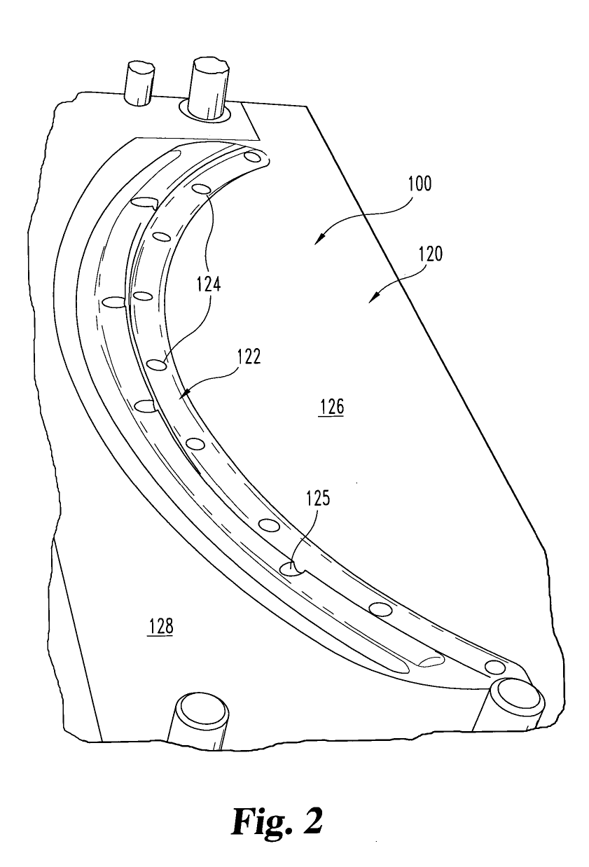

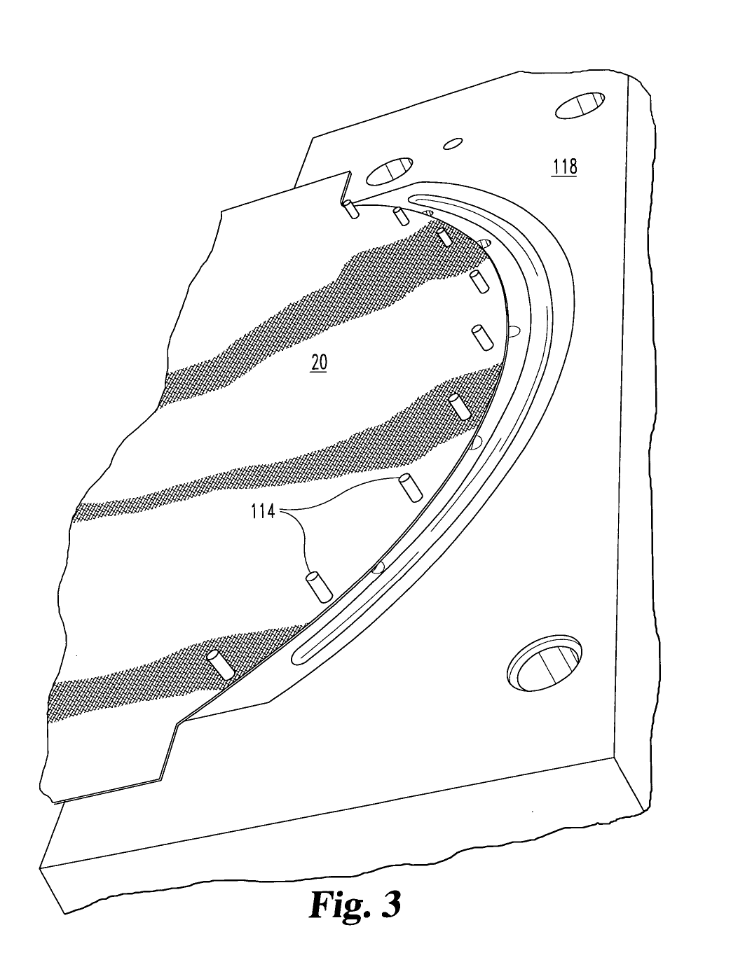

A mold for use in the present invention and a method are illustrated in FIGS. 1-3. Mold 100 includes a lower portion 110 and an upper portion 120. Lower portion 110 defines a molding lower cavity 112, having an height and width, illustrated as extending substantially the horizontal length of lower portion 110. The lower cavity is defined between an inner periphery 116 and an outer periphery 118. The lower cavity 112 may have a substantially constant width along its length. In an option for one preferred embodiment, one or more pass-through members, such as placement stakes 114 extend upward within lower cavity 112.

Upper mold portion 120 defines an upper mold cavity 122, having an height and width, illustrated as extending substantially the horizontal length of upper portion 120. The upper cavity is defined between an inner periphery 126 and an outer periphery 128. Preferably the upper cavity 122 is symmetric to the lower cavity. In an option for one preferred embodiment, one or more stake holes or recesses 124 are defined in upper cavity 122. Lower portion 110 and/or upper portion 120 define one or more injection ports 115 and/or 125 in fluid communication with the mold cavity. Lower cavity 112 and upper cavity 122 may have smooth or textured surfaces as desired, for example, a texture of a grid pattern to enhance gripping and traction.

Lower portion 110 and upper portion 120 are made in matched sizes to be closed as mold 100. When the mold portions are closed, lower cavity 112 and upper cavity 122 form an enclosed cavity defining the size and shape of the intended injection molded product. When closed, outer peripheries 118 and 128 form a substantially sealed portion, while inner peripheries 116 and 126 form a substantially sealed portion, discussed further below. In a feature shown, one or more stakes 114 extend through the enclosed cavity and the upper ends are received in matching recesses 124. Lower portion 110 and upper portion 120 may have posts, ridges, channels, recesses or similar indicia to allow the mold to align and close properly.

Mold 100 is formed of known materials for an injection mold, typically steel or a similar metal. The mold clamping portions are preferably suitable to be placed under pressure and heated while a liquid plastic material is injected into the enclosed cavity and then cured by holding and cooling. A conventional injector or injectors are used.

When used in accordance with the present invention, a fabric-type permeable material 20 is placed over lower mold portion 110 with a portion, such as end edge 22, aligned with and typically within lower cavity 112. In a preferred feature, openings, such as eyelets 25, defined in the material 20 are placed over pass-through members, such as stakes 114. Preferably in the present embodiment, the material is aligned to be substantially flat over the inner periphery 116, forming a continuous and uniform interface, without wrinkles.

The mold 100 is then closed and clamped or placed under pressure, with upper portion 120 engaging lower portion 110. Preferably, the inner peripheries of the mold portions are substantially sealed closely adjacent each other with pressure, while the material 20 remains substantially flat between them. A liquid plastic is then injected under pressure into the upper and lower cavity in the mold and air is removed or allowed to escape. Preferably, liquid plastic is injected in the upper and lower cavities simultaneously. Preferably, the fabric end 22 in the cavity “floats” in the injected material as the cavity is filled and the liquid plastic permeates the fabric material. In certain embodiments, the liquid plastic includes portions at least partially above and below the fabric material with a plastic matrix communicating or passing through the material. The plastic material is then cooled/cured, substantially embedding and locking the fabric material in a plastic matrix. When ready, the mold is opened and the finished molded end 26 is removed. As an example, some mold operation parameters are provided. These parameters can be varied by those of skill in the art while the process is still within the scope of the present invention. For example, the mold may have a clamping pressure or 61 kg/cm² and operate at a temperature of 205 degrees Centigrade. In use, the liquid plastic is injected in a 6 second cycle and the pressure is held stable for approximately 1.5 seconds while the plastic settles. The mold then has a cooling time of 13 seconds before the part is ejected. One example plastic material is a Polypropylene—PP Copolymer. In this arrangement, the overall cycle time is approximately one minute. An example mold size is 55 cm×28 cm×18.2 cm. Other examples of plastic molding materials include polymer materials such as polyamide, polyacetal, polyvinylchloride, polyethelene, polycarbonate or a Nylon(g material. Preferably, the plastic in a liquid state is of low enough viscosity to permeate through the fabric material.

Preferably a woven style fabric material is used. In one preferred embodiment, the fabric in formed from a woven mesh of polyester yarns which are coated with vinyl prior to weaving. Portions of the fabric may optionally be bonded or sealed with heat. The woven mesh is preferably in a range of 4×4 to 30×30 threads per square inch, with one preferred weave of 15 threads per inch by 13 double threads per inch.

In certain embodiments, the fabric is formed of threads of a Nylon® material, cloth or other natural, synthetic or plastic materials. The material preferably bonds or interacts well with the liquid plastic during injection and as a finished piece. Preferably the fabric material is selected to not melt, disfigure or lose strength when subjected to the mold pressure and temperature. In one option, one or more openings such as holes are defined or punched through the material to allow injected liquid plastic to flow or permeate through the openings, facilitating the bonding of the plastic to the material and bonding between upper and lower plastic portions.

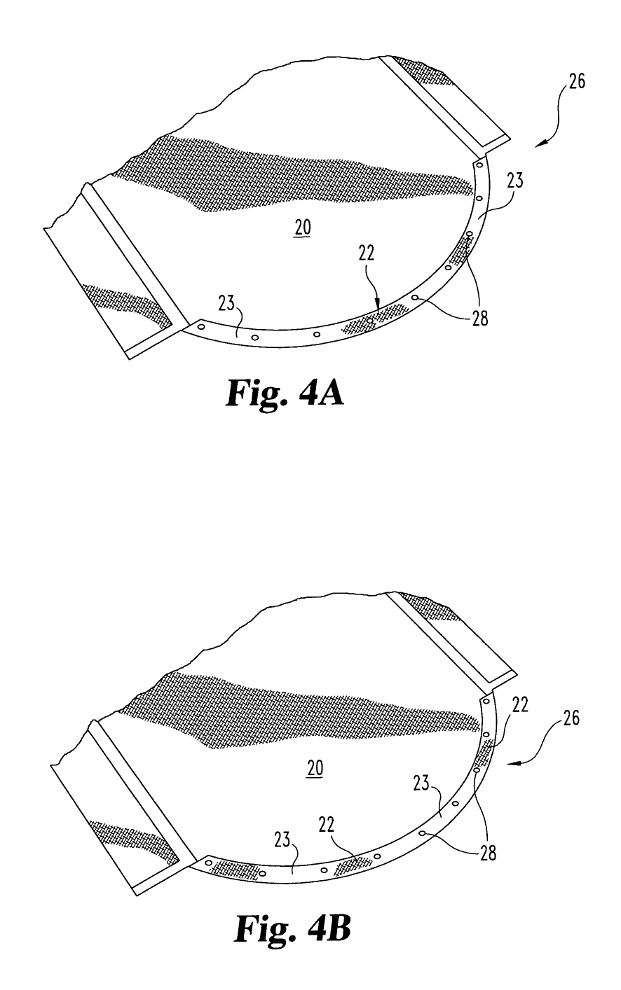

Finished molded end portion 26, shown in FIGS. 4A and 4B, includes fabric or material end portion 22 continuously integrated into the plastic material 23 in a web along the width of molded end 26. Due to floating, pieces of the end portion 22 of the permeable material are typically at various heights in the cross-section of the plastic 23 along the width of molded end 26. As shown in FIGS. 4A and 4B, the impregnated and integrated fabric end portion 22 may be visible along portions of the top or bottom of the finished molded end portion 26 depending on how the fabric floats in the mold. As an optional feature in the preferred embodiment illustrated, molded end 26 includes molded eyelets 28 formed by the locations of stakes 114 in the mold.

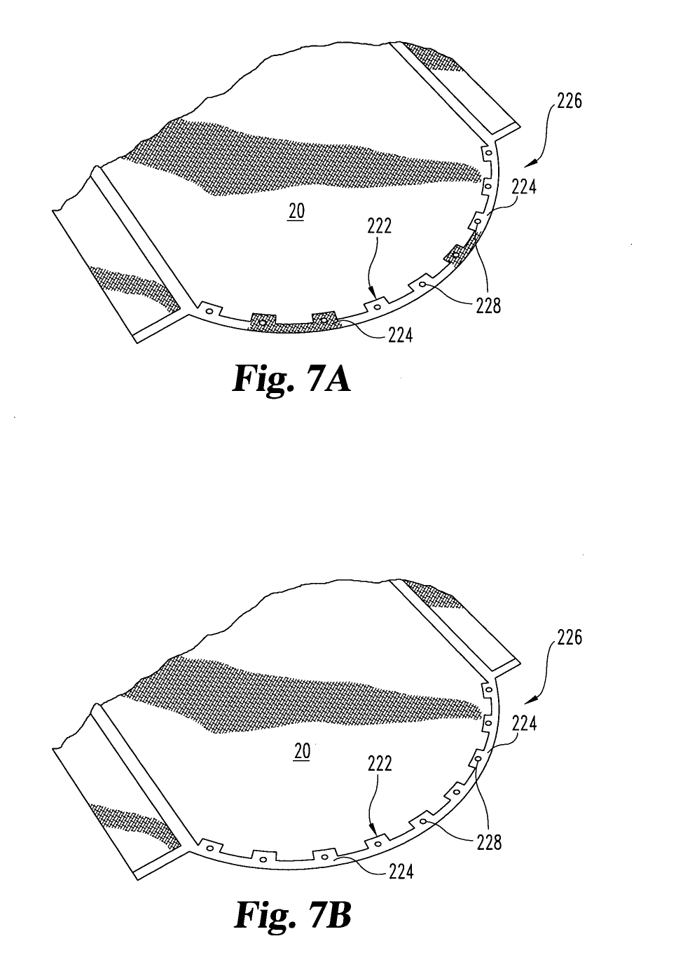

An alternate finished molded end portion 226, shown in FIGS. 7A and 7B, includes fabric or material end portion 222 integrated into the plastic material 224 in a web along portions of the width of molded end 226. End portion 226 illustrates a plurality of plastic tab portions with slight spacings between them. As shown in FIGS. 4A and 4B, the impregnated and integrated fabric end portion 222 may be visible along portions of the top or bottom of the finished molded end portion 226 depending on how the fabric floats in the mold. As an optional feature in the preferred embodiment illustrated, molded end 226 includes molded eyelets 228 formed by the locations of stakes 114 in the mold. The web or tab portions are typically adjacent and surrounding the pass-through members in the mold, such as stakes 114, and thus adjacent the resulting eyelets. The spaced tab portions preferably minimize puckering between the fabric and the finished end portion.

A molded end portion or edge is shown for illustration in the present embodiment. As desired, other portions of the material may be placed in a mold for a particular use, and the mold cavity may be shaped as desired. As one example, a middle portion of the material can be placed in the molding cavity, with material portions extending beyond and clamped between the inner peripheries and the outer peripheries of the upper and lower mold portions. As another example, multiple ends, multiple sides or edges and/or substantially the entire periphery of a material piece can be integrated into one or more finished portions. Multiple portions may be molded simultaneously or separately.

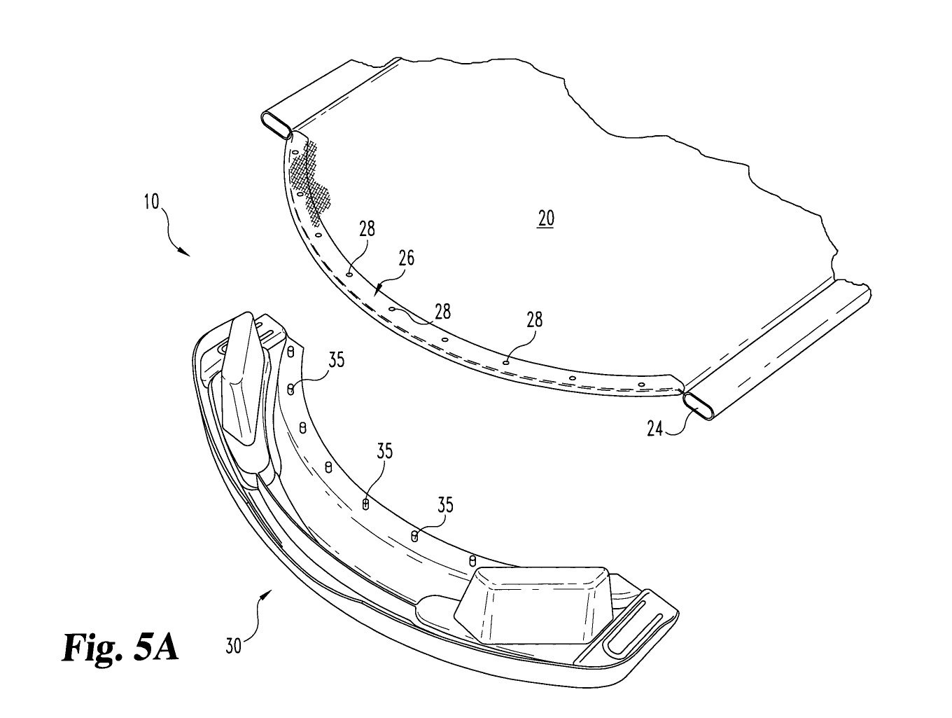

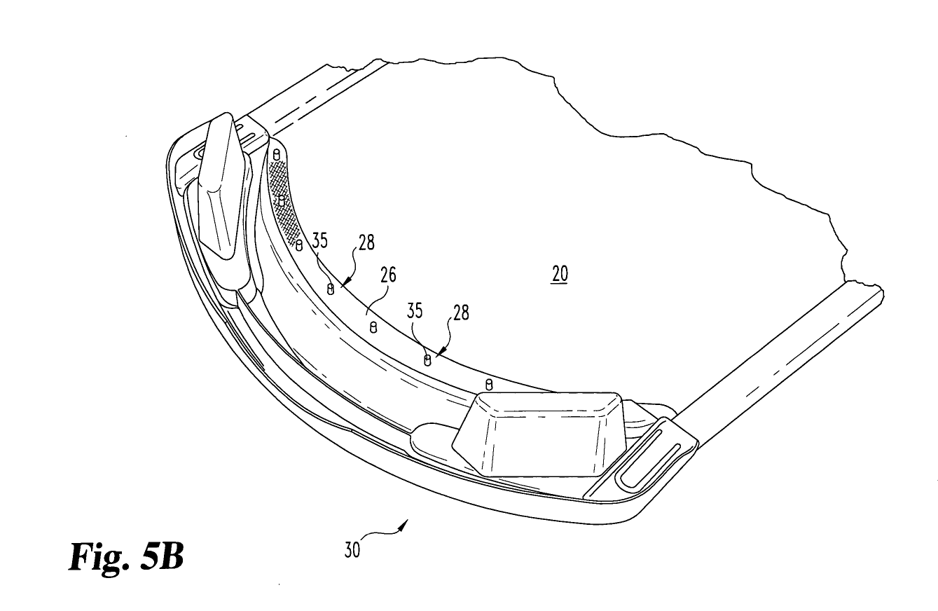

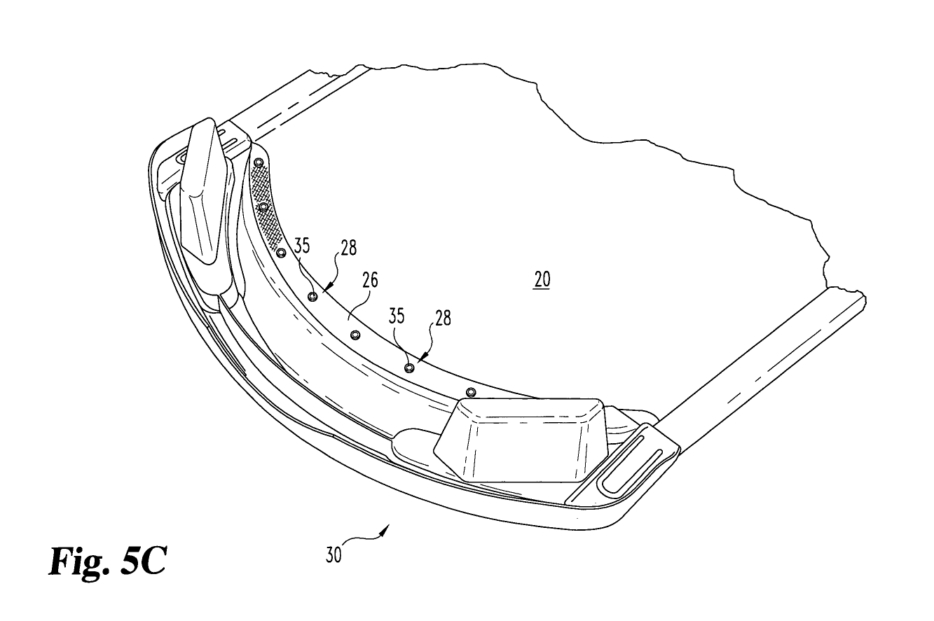

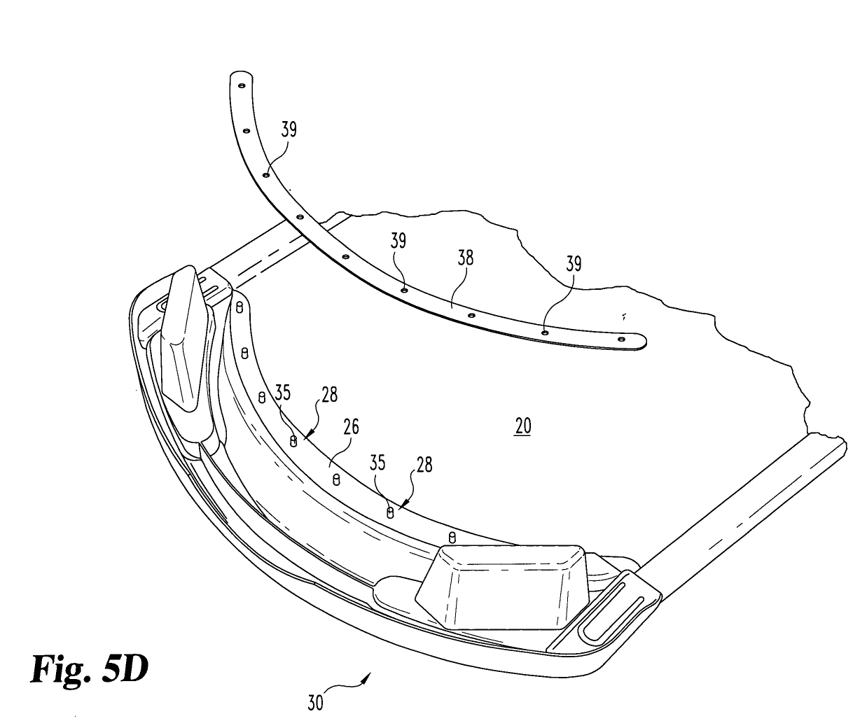

FIGS. 5A-D and 6 illustrate an article made using the present invention. A cot is illustrated as one example, but the invention encompasses various articles incorporating a fabric to plastic interface. U.S. Patent Application Ser. No. 60/496,534 filed on Aug. 20, 2003, U.S. Patent Application Ser. No. 60/541,084 filed on Feb. 2, 2004 and U.S. patent application Ser. No. 10/910,758 filed on Aug. 3, 2004 all entitled STACKABLE COT ASSEMBLY WITH ATTACHED END PIECES, describe in detail certain cot assemblies in which the present invention can be used. These applications are hereby incorporated by reference.

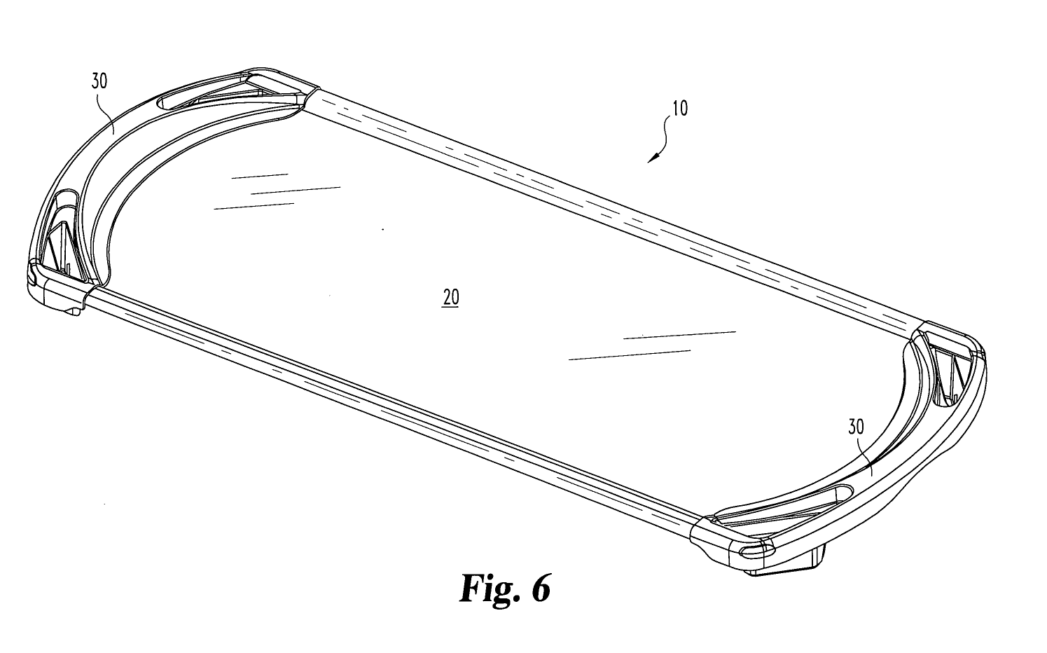

In one preferred embodiment, the present invention provides a cot assembly 10 (FIG. 6). The cot includes a bedding material or fabric 20 that spans the entire interior of the cot frame, preferably without any gaps being present between the bedding material and the frame. The bedding material 20 and side frame portions are mounted to and supported by two end pieces 30 which securely and safely receive and hold the side frame portions and material. The side frame portions and ends form a perimeter which defines an interior area with fabric 20 in which a person lying on the cot is supported. Traditionally a cot is flat and rectangular, although other geometric shapes may be used.

Referring in particular to FIGS. 5A-C and 6, there is shown a cot 10 having two side frame pieces and two end pieces 30. Bedding material or fabric 20 has end edges connected to end pieces 30 and includes sleeves 24 on the side edges to receive the side frame pieces. Fabric 20 extends in the interior area to create a support surface for a person lying on the cot. The bedding fabric 20 extends horizontally substantially parallel to the floor, ground or support surface. The bedding fabric 20 is made from a material of suitable strength and comfort to support a person lying on the cot 10, the selection of which is within the ordinary skill in the art. Bedding fabric is typically a relatively thin, flexible and compliant material, preferably sheet-like in shape. The material may be any suitable one, e.g., a natural or synthetic sheeting, fabric, mat, webbing or the like. The material may be woven. Preferably the material has a higher melting point than the heated mold temperature and the temperature of the liquid plastic and is compatible to be impregnated or permeated with liquid plastic during the injection process.

An end piece 30 is shown upside down in FIGS. 5A-C, the opposing end piece is symmetric. As illustrated, end piece 30 includes one or more securing members, such as protruding stakes 35 along the inner periphery (for example, nine stakes are shown). For one method of assembly, shown in FIGS. 5A-C, the finished end portion 26, has molded eyelets 28, which are aligned with and placed over stakes 35 of end piece 30 (FIG. 5B). The ends of stakes 35 are then heated and melted, bent, placed under pressure or otherwise deformed to form a plug to lock end portion 26 in place and thus retain material 20 to end piece 30 (FIG. 5C). Preferably this method of construction permanently connects material 20 to each end piece 30.

In an alternate assembly method, shown in FIG. 5D, a securing piece 38, having stake holes 39, is aligned and placed over stakes 35, over the molded end portion 26 and molded eyelets 28, so that stakes 35 extend all or partially through stake holes 39 and securing piece 38.

The stakes are then heated and melted, bent, placed under pressure or otherwise deformed to form a plug to locking securing piece 38 in place, sandwiching end portion 26 between cot end piece 30 and securing piece 38. As examples, securing piece 38 can be a strip of plastic or metal.

In the preferred embodiment shown, stakes 35 are formed integrally with end pieces 30. Alternately, less preferred securing members, such as rivets, bolts and nuts or screws could be used. Still further, alternate connection methods such as a clamping mechanism or a side-entry receiving channel or slot can be used to attach the fabric end piece 26 to the cot end piece 30.

End piece 30 may be made from a variety of materials, as would be understood by those of skill in the art. Examples include plastic, metal or wood. Preferably end pieces 30 are cast or injection molded plastic.

An illustration of a finished cot is shown in FIG. 6. Preferably no gaps are formed between fabric 20 and the end pieces 30. As used herein, the term “gap free” or similar terms are used to describe the fact that the bedding material fills the interior of the area defined by the frame perimeter and the end pieces when viewed in the plan view. Moreover, a preferred feature of the present invention is the provision of a gap free condition that is maintained while the bedding material is stretched during use.

Also preferably, fabric 20 has a continuous or substantially distributed interface between the fabric and the end piece, minimizing potential point failure sources. Preferably, the molded end portion contour matches the desired end piece connection portion. Typically, an even distribution of material (i.e. unwrinkled) minimizes stresses compared to gathers or uneven stretching. The interface is illustrated herein as flat; however, alternate patterns can be used as desired. Examples of alternate interfaces include horizontal or vertical curves, corrugations, zig-zags or gathered portions.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A method, comprising:
a. aligning a permeable material portion in a plastic injection mold with a mold cavity;
b. closing said mold to substantially seal said material portion in said mold cavity;
c. injecting a liquid plastic material into said mold cavity, wherein said liquid plastic permeates said material portion;
d. curing said liquid plastic material to embed said material portion within a plastic portion to form a finished portion.

2. The method of claim 1, wherein said aligning comprises placing said permeable material portion substantially evenly in said mold cavity.

3. The method of claim 2, wherein said aligning comprises placing said permeable material portion substantially flat in said mold cavity.

4. The method of claim 2, wherein said aligning comprises placing openings defined in said permeable material portion over a plurality of pass-through members in said mold cavity.

5. The method of claim 4, wherein said finished portion comprises a plurality of spaced plastic and material permeated portions correspondingly adjacent said plurality of pass-through members.

6. The method of claim 4, wherein said finished portion forms a substantially continuous web across an edge of said permeable material portion.

7. The method of claim 1, wherein said mold cavity extends substantially across an edge of said permeable material portion.

8. The method of claim 1, comprising heating said plastic material to a liquid state, and wherein said permeable material portion has a melting point greater than the temperature of said liquid plastic material in said liquid state.

9. The method of claim 1, wherein said permeable material portion is woven.

10. The method of claim 9, wherein said permeable material portion is synthetic.

11. The method of claim 1, comprising floating said permeable material portion in said mold cavity while injecting said liquid plastic material.

12. The method of claim 1, comprising securing said finished portion to a cot end piece.

13. The method of claim 12, comprising aligning pass-through openings defined in said finished portion over securing members on said cot end piece.

14. The method of claim 13, comprising deforming said securing members to secure said finished portion to said cot end piece.

15. The method of claim 14, comprising deforming said securing members with heat.

16. The method of claim 13, comprising arranging a securing piece over said securing members to sandwich said finished portion between said cot end piece and said securing piece.

17. A combination, comprising, a portion of a permeable material and a cured plastic material permeating said portion of said permeable material; wherein said portion of said permeable material is embedded in said plastic material.

18. The combination of claim 17 wherein said permeable materials is a woven synthetic material.

19. The combination of claim 17, wherein the height of said permeable material varies within the cross-sectional height of said plastic material.

20. The combination of claim 17, wherein said portion of said permeable material and a cured plastic material is secured to a cot end piece.

21. The combination of claim 20, wherein securing members on said cot end piece extend through openings defined in said permeable material and said plastic material.

22. The combination of claim 17, wherein said portion of a permeable material is an edge of the material.

23. The combination of claim 22, wherein said cured plastic material forms a web along said edge of the material.

24. The combination of claim 23, wherein said cured plastic material forms a continuous web along said edge of the material.

25. The combination of claim 23, wherein said cured plastic material forms a plurality of spaced web portions along said edge of the material.

26. The combination of claim 25, wherein said plurality of web portions encompass a corresponding plurality of openings defined in said permeable material and said plastic material.

27. The combination of claim 22, wherein said portion of a permeable material is two opposing edges of the material.

28. The combination of claim 27, wherein said two opposing edges of said material are secured to opposing cot end pieces.

29. A cot assembly, comprising:
a. a perimeter of frame pieces and at least two end pieces defining an interior area of a cot;
b. a bedding material, wherein said bedding material completely covers said interior area of the cot whereby there are no gaps between said bedding material and said perimeter;
c. each end piece having at least one support for supporting said bedding material above a support surface;
d. said bedding material having at least two ends secured to said at least two end pieces respectively; and,
e. a plastic material permeating said at least two ends of said bedding material.

30. The cot assembly of claim 29, wherein said plastic material permeating said at least two ends is secured to said at least two end pieces respectively.

31. The cot assembly of claim 28, wherein said two ends are permeated with plastic forming a web interface between said bedding material and said end pieces.

32. The cot assembly of claim 30, wherein said two ends are permeated with plastic substantially along the width of said ends.

33. The cot assembly of claim 30, comprising securing members extending from said at least two end pieces through openings defined in said at least two ends.

34. A method, comprising:
a. defining a substantially sealed mold cavity around a fabric portion;
b. injecting a liquid plastic material into said mold cavity;
c. curing said liquid plastic material to integrally secure said fabric portion within a plastic matrix to form a finished portion.

35. The method of claim 34, comprising securing said finished portion to a cot end piece.

36. The method of claim 34, comprising arranging a plurality of pass-through members in said mold cavity to pass through said fabric portion.

37. The method of claim 35, wherein said pass-through members define a plurality of openings in said finished portion.

38. The method of claim 37, comprising passing a corresponding plurality of securing members associated with a cot end piece through said plurality of openings.

39. The method of claim 38, comprising engaging said securing members to connect said finished portion to said cot end piece.
